(19) United States
(12) Patent Application Publication
(10) Pub. No.: US 2006/0099853 A1
(43) Pub. Date: May 11, 2006

(54) Coaxial plug connector and mating connector

(76) Inventors: Fred Sattele, Loffingen-Unadingen (DE); Roland Baumgartner, Bonndorf-Wellendingen (DE)

Correspondence Address: O'Shea, Getz & Kosakowski, P.C., 1500 Main Street, Suite 912, Springfield, MA, 01115, US

(21) Appl. No.: 11/037,822

(22) Filed: Jan. 18, 2005

(30) Foreign Application Priority Data
Nov. 5, 2004 (DE) 10 2004 054 022.5

(51) Int. Cl. H01R 9/05

(52) U.S. Cl. 439/578

(57) ABSTRACT

A connector includes a plug connector and a mating connector. The plug connector includes a housing with an open front end, an insulated inner conductor disposed within the housing, a clamping sleeve and an axially movable sliding sleeve disposed radially outside the clamping sleeve. The sliding sleeve can be positioned in a working position where it surrounds the clamping sleeve and exerts a radially inward-directed force. The mating connector, which is receivable within the housing, includes a clamping surface. A force Fᵣ introduced radially from the sliding sleeve toward the clamping sleeve when the sliding sleeve is in the working position is redirected by the clamping sleeve into an axial force component Fₐ which is introduced from the clamping sleeve toward the clamping surface.

The invention relates to a coaxial plug connector and an associated mating connector as specified in the preamble of claim 1.

A plug connector/mating-connector combination of this type was disclosed, for example, in EP 1 222 717 B1. In this prior-art plug connector, a clamping sleeve pretensioned in the radial direction is used to introduce a radial force into the mating connector. This introduced radial force is redirected into an axial force component by a circumferential clamping surface inclined relative to the longitudinal axis of the mating connector. The prior-art plug connector/mating-connector combination thus always requires a clamping surface inclined relative to the longitudinal axis of the mating connector in order to redirect the initially radially introduced force into an axial force component.

The goal of the invention is to create a plug connector of the type referenced in which an outer-conductor contact surface of the mating connector can be tensioned against an outer-conductor contact surface of the plug connector, independently of the design of the clamping surface, that is, even with a clamping surface running perpendicular to the longitudinal axis of the mating connector.

This goal is achieved by the features of claim 1.

Advantageous embodiments of the invention are presented in the subclaims.

The fundamental concept of the invention is to introduce the axial force component directly from the clamping sleeve into the clamping surface of the mating connector rather than first introducing a radial force which must then be redirected at the clamping surface into an axial force component.

Since the axial force component is introduced directly, that is, by the clamping sleeve itself based on its shape into the clamping surface, there is no need for force redirection at the clamping surface—with the result that the clamping surface may, if required, run perpendicular to the longitudinal axis of the mating connector.

Because of the invention, it is no longer necessary to design the clamping surface in an inclined orientation relative to the longitudinal axis.

The design of the invention advantageously allows even a radial force component to be introduced from the clamping sleeve, that is, directly by the clamping sleeve into a compensation surface of the mating connector. As a result, all of the radial force components acting on the mating connector are compensated such that even in the case of a clamping surface with an inclined design only one axial force component is introduced into this component.

According to an improved embodiment, introduction of the axial force component from the clamping sleeve into the clamping surface is effected only by moving the clamping sleeve into the working position. This means that an axial force component is not automatically transmitted from the clamping sleeve onto the clamping surface after the plug connector and mating connector are joined. To achieve this, the sliding sleeve must be moved to the working position in which a radial force is then exerted on the clamping sleeve. As a result, the free end of the clamping sleeve is pressed axially in the direction of the clamping surface, with the result that an axial force component is introduced directly from the clamping sleeve into the mating connector. In an advantageous embodiment of the invention, the clamping sleeve is initially spaced a certain distance from the clamping surface after the plug connector and mating connector are joined, and only when the sliding sleeve is moved into the working position is the clamping sleeve moved towards the clamping surface and tensioned axially against the clamping surface.

In one modification of the invention, the introduction of the radial force component into the compensation surface is also advantageously effected only by moving the sliding sleeve into the working position. Here the clamping sleeve is initially spaced a certain distance from the compensation surface, and is then moved against the compensation surface only by moving the sliding sleeve into the working position.

A conceivable approach, of course, is to have the clamping sleeve already pretensioned radially such that a radial force component is immediately introduced directly into the compensation surface of the counterpart when the sliding sleeve is still located in a ready position and has not yet been moved into the working position.

According to an improved design variant, the clamping surface runs perpendicular to the longitudinal axis of the mating connector. In this design of the invention, the clamping surface is advantageously provided on an outside radially projecting rib of the mating connector and/or on a radially inward-pointing recess of the mating connector. It is advantageous here to design the clamping surface and/or compensation surface so as to run circumferentially around the mating connector

According to an advantageous embodiment of the invention, the clamping sleeve is shaped in such a way so as to extend from the plug connector, or from the end opening of the plug connector, axially past the clamping surface of the mating connector, the end region being bent or bent back towards the clamping surface. The end region of the clamping sleeve here specifically runs at an acute angle to the longitudinal axis of the mating connector. In order to improve the tensioning effect in the axial direction, the clamping sleeve advantageously has a region flaring radially outward which is preferably located directly adjacent to the bent-back end region.

In order to provide the radial movement of the clamping sleeve, the clamping sleeve is provided with axially oriented slots, thereby forming snap-in tongues. The snap-in tongues are interconnected at one end by a circumferential ring section. Alternatively, the clamping sleeve is composed of spaced tension springs extending axially and distributed around the periphery of the plug connector.

Advantageously, the sliding sleeve surrounds the clamping sleeve even in a ready position in which the clamping sleeve does not introduce any axial force into the clamping surface. The sliding sleeve, in other words, can be moved axially between a ready position and a working position. As a rule, the sliding sleeve is designed so that even in the ready position a radial force, albeit a small one, is exerted on the clamping sleeve. However, the radial force introduced by the sliding sleeve into the clamping sleeve is sufficiently large only in the working position to enable the clamping sleeve to introduce an axial force component into the clamping surface of the mating connector.

It is of course possible to design the sliding sleeve so that no force is exerted by the sliding sleeve in the ready position on the clamping sleeve.

It is advantageous to have the clamping sleeve at its outer radial, specifically, end region be received within a recess on the inner circumference of the sliding periphery. The recess advantageously has a radially tapering axial section, thereby enabling the sliding sleeve to move axially more easily from the ready position into the working position.

The following discussion explains the invention in more detail based on the drawings.

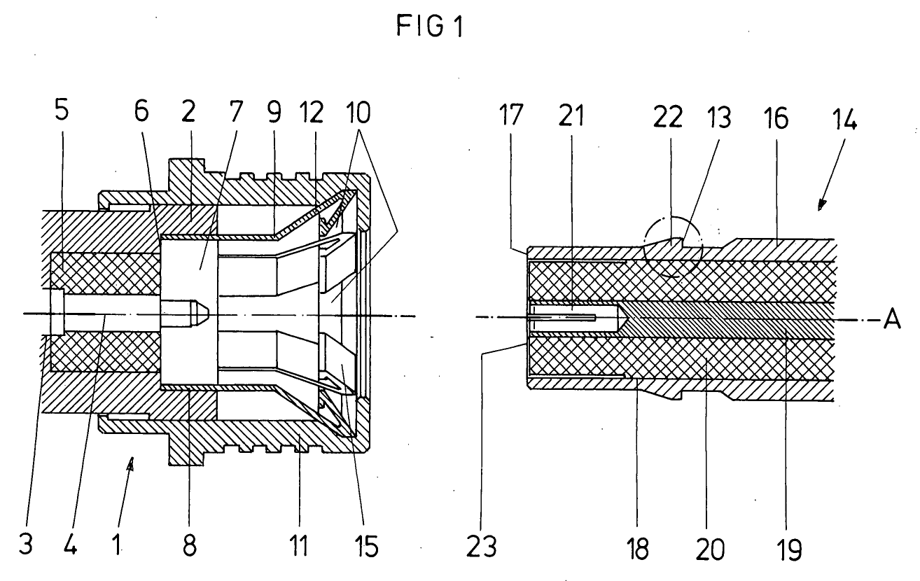

FIG. 1 is a section through a plug connector according to the invention, as well as a section through a mating connector separated from the plug connector;

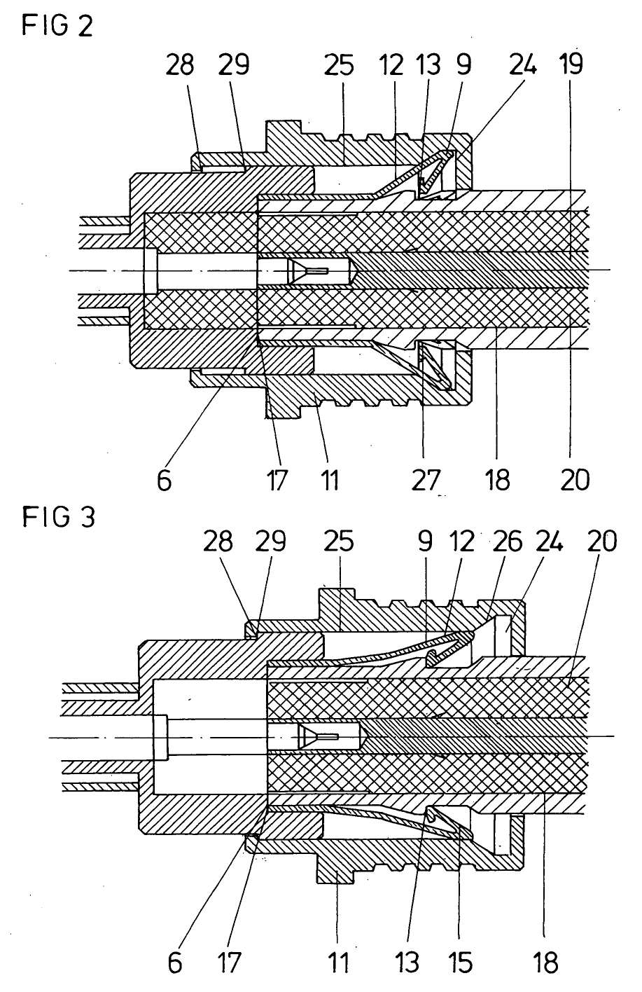

FIG. 2 is a section through the plug connector with attached mating connector and including a sliding sleeve in the ready position;

FIG. 3 is a section through the plug connector with attached mating connector and including a sliding sleeve in the working position; and

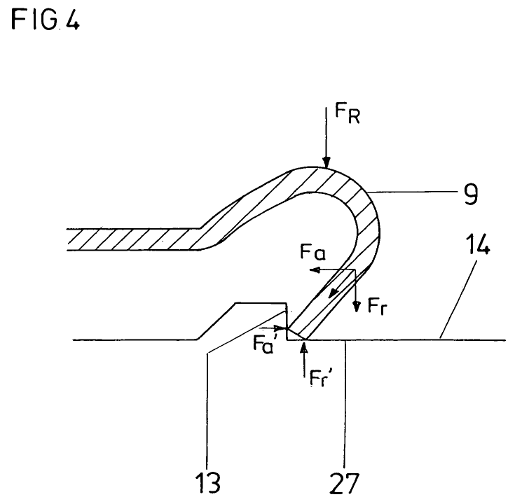

FIG. 4 is a schematic enlargement showing details from FIG. 3.

A plug connector 1 is shown on the left side of FIG. 1. The coaxial plug connector 1 has a housing 2 which is open at the front end and is traversed by a channel 3. An inner conductor contact 4 is located in channel 3 and insulated from the plug connector housing 2 by a sleeve-like insulator 5. Plug connector housing 2 forms an outer conductor and has in the end opening an annular circumferential outer-conductor contact surface 6. The end of insulating sleeve 5 is flush with this outer contact surface 6.

Within the front-end opening of plug connector 1, a clamping sleeve 8 projecting axially is attached which is pressed radially into opening 7. Clamping sleeve 8 is provided with axial slots 10, thereby creating multiple spring-elastic snap-in tongues.

A sliding sleeve 11 which is axially movable within a limited extent surrounds clamping sleeve 8. In FIGS. 1 and 2, sliding sleeve 11 is located in a ready position in which it does not exert any force on snap-in tongues 9.

Snap-in tongues 9 run axially and parallel to the longitudinal axis A of plug connector 1, starting from a circumferentially closed region. Adjoining this area is a region 12 expanding radially outward at an angle. As is seen in FIG. 2, snap-in tongues 9 together with widening region 12 are diverted axially along a clamping surface 13 of a mating connector 14. A region 15 of snap-in tongues 9 bent back towards front-end opening 7 directly adjoins region 12 of snap-in tongues 9 which widens radially outward. With this bent-back region 15, snap-in tongues 9 are returned axially towards clamping surface 13 and radially towards longitudinal axis A of mating connector 14. As is shown, the last end piece of snap-in tongues 9 is one again bent back and runs radially outward so as to form an enlarged support surface on clamping surface 13.

Mating connector 14 has an outer conductor in the form of an essentially cylindrical housing 16. At its front end, housing 16 has an annular circumferential outer-conductor contact surface 17. An insulator 20 is located in a continuous channel 18 of this housing 16, a conductor 19 being located within this insulator. At the front end of conductor 19, a socket 21 is provided to receive inner conductor contact 4 of plug connector 1, the inner conductor contact projecting axially towards the mating connector.

In the embodiment shown, clamping surface 13 is located on a rib 22 of mating connector 14, the rib projecting radially outside, while clamping surface 13 runs orthogonally relative to longitudinal axis A of mating connector 14.

In FIG. 2, mating connector 14 is attached to plug connector 1. To accomplish this, mating connector 14 is inserted axially by its front end into clamping sleeve 8 until the two contact surfaces 6 and 17 make contact. During the attachment process in the embodiment shown, clamping sleeve 8 is briefly stretched elastically in a radial direction. This does not necessarily have to occur, however. The relative gap between snap-in tongues 9 can be dimensioned in such a way that mating connector 14 can move into the position shown in FIG. 2 without snap-in tongues 9 having to be expanded radially. As was mentioned, sliding sleeve 11 in FIG. 2 is located in the ready position in which it surrounds all snap-in tongues 9. Snap-in tongues 9 are received at their radially outer end regions within a circumferential recess 24 on the inner periphery 25 of sliding sleeve 11. Recess 24 is dimensioned such that sliding sleeve 11 does not exert any radial force on clamping sleeve 8. Recess 24 has an axial section 26 which narrows radially. In the ready position shown in FIG. 2, snap-in tongues 9 do not contact either clamping surface 13 or a compensation surface 27 of mating connector 14, which surface runs parallel to longitudinal axis A of mating connector 14. Consequently, no force is exerted by snap-in tongues 9 on mating connector 14.

FIG. 3 shows sliding sleeve 11 in a working position. For this purpose, sliding sleeve 11 has been moved from the retracted ready position shown in FIG. 2 axially towards mating connector 14. The axial movement is limited by a circumferential, inward-pointing edge 28 provided on the end of sliding sleeve 11, this edge coming to rest on a radially outward-facing opposing surface 29 of plug connector housing 2.

During the axial movement of the sliding sleeve, the axial section 26 is displaced along the radially expanding axial section 12 of snap-in tongues 9 until the radially outer-most region of snap-in tongues 9 comes to rest on inner periphery 25, running parallel to longitudinal axis A, of the sliding sleeve. As a result, a radial force F_{R} is applied by snap-in tongues 9 which generates in elastic tongues 9 an axial force component Fₐ that is introduced directly into clamping surface 13 of mating connector 14. As FIG. 3 shows, snap-in tongues 9 deform in the working position of sliding sleeve 11 in such a way that the original kinked shape of the snap-in tongues is almost completely straightened out.

FIG. 4 schematically illustrates the force pattern of the working position shown in FIG. 3 for snap-in tongue 9. As explained above, a radial force F_{R} is introduced into snap-in tongues 9 in the working position by sliding sleeve 11. As a result, an axial force component Fₐ and a radial force component Fᵣ are created in snap-in tongues 9. Axial force component Fₐ is introduced directly from the free ends of snap-in tongues 9 into the clamping surface 13 running perpendicular to longitudinal axis A of mating connector 14 where it generates a counterforce F_{a′}. Radial force component Fᵣ is introduced directly from the free ends of snap-in tongues 9 into compensation surface 27 which surrounds mating connector 14 and runs parallel to longitudinal axis A of the mating connector where it generates a counterforce or compensation force Fᵣ. In contrast to the design shown schematically in FIG. 4, it is of course also possible for the free ends of snap-in tongues 9 to rest flat against the clamping surface and/or compensation surface 27.

Due to the fact that all the radial force components Fᵣ are compensated on compensation surface 27, only axial force component Fₐ is introduced into clamping surface 13, despite the fact that clamping surface 13 is of an angled design with respect to longitudinal axis A of mating connector 14.

### LIST OF REFERENCE NOTATIONS

1 plug connector
2 plug connector housing
3 channel
4 inner conductor contact
5 insulator
6 outer conductor contact surface
7 front-end housing opening
8 clamping sleeve
9 snap-in tongues
10 axial slots
11 sliding sleeve
12 radially flared section of snap-in tongues
13 clamping surface
14 mating connector
15 bent-back or bent-over region of snap-in tongues
16 housing
17 outer conductor contact surface
18 channel
19 conductor
20 insulator
21 socket
22 rib
23 front end
24 recess
25 inner periphery
26 radially narrowing axial section of recess 24
27 compensation surface
28 edge
29 opposing surface
F_{R} radial force
Fₐ axial force component
F_{a′} counterforce to the axial force component
Fᵣ radial force component
F_{r′} counterforce to the radial force component
A longitudinal axis

1. Coaxial plug connector and mating connector, wherein the plug connector comprises housing with an open front end that allows attachment of a mating connector and which is traversed by a channel in which an insulated inner conductor contact is located, including a clamping sleeve and an axially movable sliding sleeve to mechanically connect the housing to the mating connector, wherein the sliding sleeve can be positioned in a working position where it surrounds the clamping sleeve and exerts a radially inward-directed force, and wherein the clamping sleeve can be moved into contact with a clamping surface on the mating connector, and wherein an outer-conductor contact surface of the mating connector is axially tensionable against an outer-conductor contact surface of the plug connector, wherein a force Fᵣ introduced radially from the sliding sleeve toward the clamping sleeve when the sliding sleeve is in the working positioned is redirected by the clamping sleeve into an axial force component Fₐ which is introduced directly from the clamping sleeve toward the clamping surface.

2. Coaxial plug connector and mating connector according to claim 1, wherein a radial force component Fᵣ is introduced from the clamping sleeve directly toward a compensation surface of the mating connector.

3. Coaxial plug connector and mating connector according to claim 1, wherein one or both of the axial force component Fₐ from the clamping sleeve toward the clamping surface, and the radial force component Fᵣ toward the compensation surface is created by moving the sliding sleeve into the working position.

4. Coaxial plug connector and mating connector according to claim 1, wherein the clamping sleeve is movable into contact with the clamping surface moving the sliding sleeve into the working position.

5. Coaxial plug connector and mating connector according to claim 1, wherein the clamping surface runs perpendicular to a longitudinal axis A of the mating connector.

6. Coaxial plug connector and mating connector according to claim 1, wherein a compensation surface runs parallel to a longitudinal axis A of the mating connector.

7. Coaxial plug connector and mating connector according to claim 1, wherein the clamping surface is provided on one or both of an outside radially projecting rib of the mating connector and a radially inward-pointing recess of the mating connector.

8. Coaxial plug connector and mating connector according to claim 1, wherein one or both of the clamping surface and a compensation surface surrounds the mating connector.

9. Coaxial plug connector and mating connector according to claim 1, wherein the clamping sleeve is diverted axially past the clamping surface, and an end region is bent back or bent in the direction of the clamping surface.

10. Coaxial plug connector and mating connector according to claim 9, wherein the clamping sleeve has a radially outward expanding region adjacent the end region.

11. Coaxial plug connector and mating connector according to claim 1, wherein the clamping sleeve is provided with axially oriented slots.

12. Coaxial plug connector and mating connector according to claim 1, wherein the sliding sleeve surrounds the clamping sleeve in a ready position in which the clamping sleeve does not introduce substantially any axial force component Fₐ into the clamping surface.

13. Coaxial plug connector and mating connector according to claim 1, wherein the clamping sleeve includes an end region and the end region is received within a recess disposed within the sliding sleeve.

14. A connector, comprising:
a plug connector having a housing with an open front end, an insulated inner conductor disposed within the housing, a clamping sleeve, and an axially movable sliding sleeve disposed radially outside the clamping sleeve;
wherein the sliding sleeve can be positioned in a working position where it surrounds the clamping sleeve and exerts a radially inward-directed force; and
a mating connector receivable within the housing, the mating connector having a clamping surface;
wherein a force Fᵣ introduced radially from the sliding sleeve toward the clamping sleeve when the sliding sleeve is in the working position, is redirected by the clamping sleeve into an axial force component Fₐ which is introduced from the clamping sleeve toward the clamping surface.

15. A connector, comprising:
a plug connector having a housing with an open front end, an insulated inner conductor disposed within the housing, a clamping sleeve, and an axially movable sliding sleeve disposed radially outside the clamping sleeve;
wherein the sliding sleeve is positionable in a first position where it exerts a radially inward-directed force toward the clamping sleeve, and in a second position where it exerts substantially no radially inward-directed force toward the clamping sleeve; and
a mating connector receivable within the housing, the mating connector having a clamping surface.

16. The connector of claim 15, wherein the radially inward directed force exerted by the sliding sleeve toward the clamping sleeve in the first position, is redirected by the clamping sleeve into an axial force which is directed from the clamping sleeve toward the clamping surface.

17. The connector of claim 16, wherein the mating connector includes a compensation surface; and
wherein the radial force is directed from the clamping sleeve toward the compensation surface.

18. The connector of claim 17, wherein a compensation surface runs parallel to a longitudinal axis of the mating connector.

19. The connector of claim 17, wherein one or both of the clamping surface and the compensation surface surrounds the mating connector.

20. The connector of claim 16, wherein one or both of the axial force and the radial force is created by moving the sliding sleeve into the first position.

21. The connector of claim 15, wherein the clamping sleeve is movable into contact with the clamping surface by moving the sliding sleeve into the first position.

22. The connector of claim 15, wherein the clamping surface extends perpendicular to a longitudinal axis of the mating connector.

23. The connector of claim 15, wherein the clamping surface is provided on one or both of an outside radially projecting rib of the mating connector and a radially inward-pointing recess of the mating connector.

24. The connector of claim 15, wherein the clamping sleeve is diverted axially past the clamping surface, and an end region is bent back or bent in the direction of the clamping surface.

25. The connector of claim 24, wherein the clamping sleeve has a radially outward expanding region adjacent the end region.

26. The connector of claim 15, wherein the clamping sleeve is provided with axially oriented slots.

27. The connector of claim 15, wherein the clamping sleeve includes an end region and the end region is received within a recess disposed within the sliding sleeve.
